(19) United States
(12) Patent Application Publication
(10) Pub. No.: US 2010/0053065 A1
(43) Pub. Date: Mar. 4, 2010

(54) FLAT DISPLAY APPARATUS ADAPTED FOR INSTANTLY REPORTING AN ABNORMAL OPERATION STATUS

(75) Inventors: Chung-Ming Hu, Taipei City (TW); Li-Ying Kuo, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: ORIPIX COMPANY LIMITED, Taipei City (TW)

(21) Appl. No.: 12/548,679

(22) Filed: Aug. 27, 2009

(30) Foreign Application Priority Data
Aug. 27, 2008 (TW) 097132684

(51) Int. Cl. G09G 3/36

(52) U.S. Cl. 345/102

(57) ABSTRACT

A flat display apparatus is disclosed. The flat display apparatus includes an abnormal operation status detector and an abnormal signal transceiver, and is adapted for instantly reporting an abnormal operation status. The abnormal operation status detector is adapted for detecting an abnormal operation status of the flat display apparatus and generating a corresponding abnormal signal. The abnormal signal transceiver receives the abnormal signal and then transmits the abnormal signal to a suitable receiver so as to actively detect the operation status of the flat display apparatus for reporting to the receiver, thus providing a high efficiency maintenance mechanism and an instant monitoring system.

### BACKGROUND OF THE INVENTION

1. Field of the Invention

The present invention relates generally to a flat display apparatus, and more particularly, to a flat display apparatus adapted for reporting an abnormal operation status.

2. The Prior Arts

Flat display apparatuses, having the advantages of low power consumption and small size, are more and more widely used in different application fields. For example, electronic display boards are often used for public information display (PID). They are usually installed in public places, such as shopping malls, department stores, airports, or subway stations. Currently, the electronic display boards or light boxes are now gradually replaced by flat display apparatuses which can dynamically display images, so as to more actively attract the public's attention.

However, when an LCD display is used for a long time, the luminance of the LCD display will decrease. That means the LCD display is aged. Further, when the lamps of the backlight module of the LCD display are frequently turned on and off, the backlight module may be damaged, which may even further cause the LCD electronic display board failing to display images, thus causing loss of commercial profit.

According to a conventional technology, a typical flat display apparatus includes an independent power supplier for providing a stable electrical power, and an inverter for starting the lamps of the backlight module. When one of the lamps is out of order and is extinguished, an internal mechanism is then started to turn off all of the lamps. Accordingly, the operation of the display apparatus is then ended. In other words, the failure of any one of the lamps will cause the whole display apparatus to stop operation. When the user finds out the failure, he usually calls the customer service number for requesting a maintenance service or asking for a replacement. This process may last a long time, during which the flat display apparatus must remain out of use, thus causing loss of commercial profit.

The conventional technology lacks efficient error warning mechanism, and therefore takes lots of time on communication with customer service. Further, the user has to frequently take care of the operation status of the flat display apparatus, so as to report any abnormal operation status of the flat display apparatus in time. However, this requires more manpower involved.

As such, a mechanism adapted for actively detecting an abnormal operation status of the display apparatus, and a method for instantly reporting the detected abnormal operation status to the maintenance staff are desired.

### SUMMARY OF THE INVENTION

A primary objective of the present invention is to provide a flat display apparatus having a warning function. The flat display apparatus has an instant feedback mechanism so that the flat display apparatus is adapted for detecting any abnormal operation status of lamp luminance, display temperature, and rotation speed of the fan, and instantly reporting the detected abnormal operation status to the maintenance staff.

Another objective of the present invention is to provide a flat display apparatus adapted for reporting an abnormal operation status of the flat display apparatus. The flat display apparatus includes an abnormal operation status detector, and an abnormal signal transceiver. The abnormal operation status detector is adapted for detecting whether there is an abnormal operation status of the flat display apparatus. When the abnormal operation status is detected, the abnormal operation status detector generates an abnormal signal. The abnormal signal transceiver receives the abnormal signal, and transmits the abnormal signal to a predetermined receiver end. In such a way, the present operation status of the flat display apparatus can be actively detected and instantly reported to the receiver end, so as to allow the receiver end to dynamically monitor the operation of the flat display apparatus. Therefore, when an abnormal operation status occurs, the maintenance staff can be instantly informed and go to repair in time.

A further objective of the present invention is to provide a method for automatically reporting an abnormal operation status of a flat display apparatus. In accordance with the method, when there is an abnormal operation status occurs, an abnormal operation status detector generates an abnormal signal, and an abnormal signal transceiver transmits the abnormal signal to a predetermined receiver end.

Still a further objective of the present invention is to provide a bidirectional feeding back method. According to the bidirectional feeding back method, according to a data reported from a display apparatus, a control center feeds back a control instruction to the display apparatus. For example, when the control center receives an operation status reporting that there are multiple lamps are abnormal at the same time, the control center then feeds back a control instruction to turn off the backlight module of the display apparatus.

As such, the present invention is adapted for providing a solution to the difficulties of the conventional technology, in which the time used for reporting the abnormal operation status is saved, thus providing a high efficiency maintenance mechanism and an instant monitoring system.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram systematically illustrating a flat display apparatus adapted for reporting an abnormal operation status according to a first embodiment of the present invention;

FIG. 2 is a schematic diagram illustrating a flat display apparatus adapted for reporting an abnormal operation status according to the first embodiment of the present invention;

FIG. 3 is a schematic diagram illustrating a flat display apparatus adapted for reporting an abnormal operation status according to a second embodiment of the present invention;

FIG. 4 is a schematic diagram illustrating a flat display apparatus adapted for reporting an abnormal operation status according to a third embodiment of the present invention; and

FIG. 5 is a schematic diagram illustrating a flat display apparatus adapted for reporting an abnormal operation status according to a fourth embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

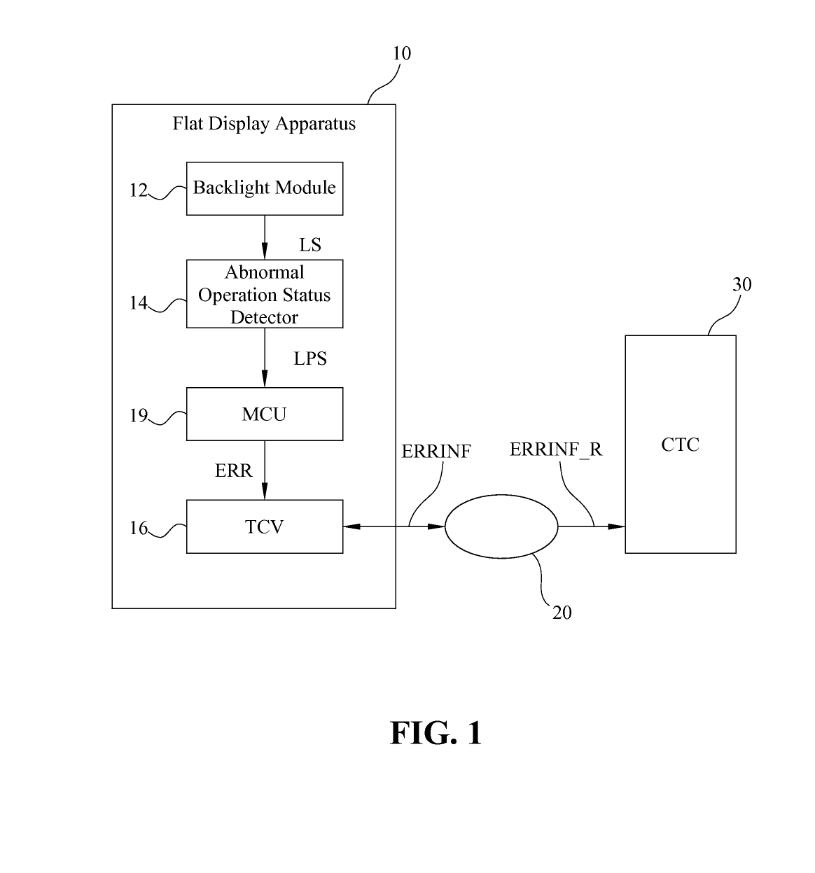

FIG. 1 is a block diagram systematically illustrating a flat display apparatus adapted for reporting an abnormal operation status according to a first embodiment of the present invention. Referring to FIG. 1, the system includes a flat display apparatus 10, a network 20, and a control center (CTC) 30. The flat display apparatus 10 has a warning function of instantly reporting an abnormal operation status. The flat display apparatus 10 includes a backlight module 12, an abnormal operation status detector 14, a micro control unit (MCU) 19, and an abnormal signal transceiver 16. It should be noted that the drawings show only the components related to the technical features of the present invention, not show other well-known components, so as to conveniently explain the present invention. That means that the flat display apparatus 10 further includes other components except the above mentioned components, which will not affect the following explanation on the present invention.

As shown in FIG. 1, the abnormal operation status detector 14 detects a lamp signal LS of the backlight module 12, and correspondingly generates a lamp operation status signal LPS, and provides the lamp operation status signal LPS to the MCU 19. The MCU 19 then determines whether a lamp of the backlight module 12 is in abnormal operation according to the lamp operation status signal LPS. For example, the MCU 19 may determine whether the lamp provides an insufficient luminance, flickers, or is even extinguished, according to the voltage level of the lamp operation status signal LPS. The MCU 19 also automatically analyzes any detected abnormal operation status of the lamp for recovering the abnormal operation, thus generating a abnormal signal ERR, and provides the abnormal signal ERR to the abnormal signal transceiver 16. In general, the lamp signal LS is an analog signal, and therefore the abnormal operation status detector 14 also has the function of an analog-to-digital converter for generating the lamp operation status signal LPS, which is a digital signal.

The abnormal signal transceiver 16 receives the abnormal signal ERR, and processes the abnormal signal ERR to obtain an abnormal information ERRINE The abnormal information ERRINF is then transmitted out via the network 20. The CTC 30 receives a receiver end abnormal information ERRINF_R corresponding to the abnormal information ERRINF from the network 20. It should be noted, the abnormal information ERRINF for example can be a network packet containing the abnormal signal ERR. Such a network packet is more convenient for transmittance in the network 20. Further, the network 20 can be a wired network or a wireless network. The CTC 30 is adapted for properly processing the received receiver end abnormal information ERRINF_R, such as recording the information, sending a message or email to inform the maintenance center, or informing other related staff for recovering the abnormal operation status.

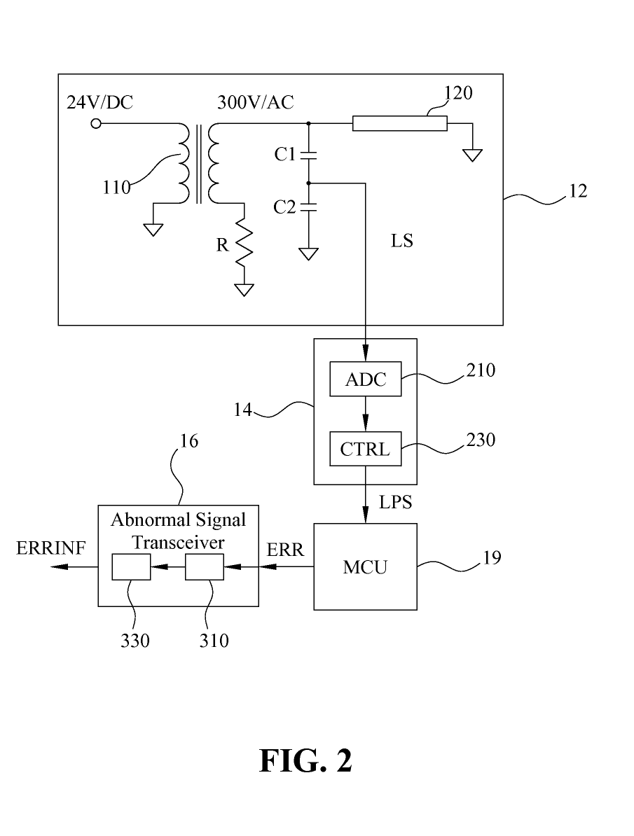

FIG. 2 is a schematic diagram illustrating a flat display apparatus adapted for reporting an abnormal operation status according to the first embodiment of the present invention. Referring to FIG. 2, the backlight module 12 includes a DC-to-AC transformer 110 converts a 24V DC power supply into a high voltage AC power supply, e.g., 300V, and provides the high voltage AC power supply to a lamp 120. As shown in FIG. 2, the high voltage end of the DC-to-AC transformer 110 is coupled with a resistance R. The lamp 120 for example can be but is not restricted to be a conventional cold cathode fluorescent lamp (CCFL). Two capacitors C1 and C2 are coupled in series, and as a whole parallel coupled to the joint of the lamp 120 and the high voltage AC power supply. A voltage at the joint between the two capacitors C1 and C2 is defined as the lamp operation status signal LPS, and is detected by the abnormal operation status detector 14.

When the lamp 120 is in a normal operation, the lamp signal LS is grounded. When the lamp 120 is in an abnormal operation, e.g., extinguished, the lamp signal has a voltage greater than 0V. The voltage depends on the capacitances of the capacitors C1 and C2. In other words, the voltage of the lamp signal LS is a fraction of the high voltage power supply on the capacitors C1 and C2.

The abnormal operation status detector 14 includes an analog-to-digital converter (ADC) 210, and a controller 230. The ADC 210 converts lamp the analog signal LS which is an analog signal into a digital signal, and transmits the digital signal to the controller 230. The controller 230 executes a predetermined processing to the received digital signal, such as a digital filtering process for eliminating interference caused by external noises, thus obtaining the lamp operation status signal LPS. Typically, facilitated with an internal clock or an external reference clock, a counter is employed for counting the digital signal. When the counted value exceeds a predetermined threshold value, the digital signal is taken as an effectively abnormal signal and correspondingly a lamp operation status signal LPS is outputted. In other words, only when a digital signal is lasted for a specific time, it can be taken as an effectively abnormal signal, or otherwise it is taken as an irrelevant noise.

The abnormal operation status detector 14 can be integrated in the MCU 19. In this case, the MCU 19 has the function of analog to digital conversion, and executes the foregoing operation by a firmware program, and also complies with the hardware operation of the controller 230 with a firmware program.

The abnormal signal transceiver 16 includes a data converter 310, and a transferring interface 330. The data converter 310 is adapted to convert the abnormal signal ERR inputted thereto into data in an appropriate format, e.g., a packet format required by the network transmission protocol. Then, the transferring interface 330 receives the data and transfers the data with the abnormal information ERRINF via the network 20. It should be noted that the format of the abnormal information ERRINF is not restricted by the present invention, and any other format suitable for being transferred by the corresponding network and can be received and read to obtain the abnormal operation status signal from the data can be applied.

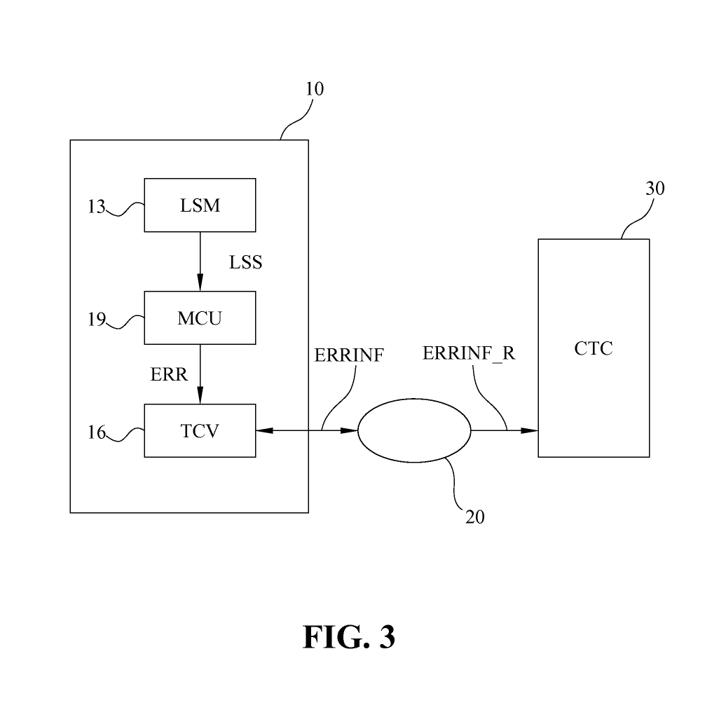

FIG. 3 is a schematic diagram illustrating a flat display apparatus adapted for reporting an abnormal operation status according to a second embodiment of the present invention. Referring to FIG. 3, the system includes a flat display apparatus 10, a network 20, and a control center (CTC) 30. The flat display apparatus 10 is adapted for instantly reporting an abnormal operation status of the flat display apparatus 10. The flat display apparatus 10 includes a light sensing module (LSM) 13, a micro control unit (MCU) 19, and an abnormal signal transceiver 16. The LSM 13 is adapted for detecting a luminance of a lamp, and correspondingly generating a lamp luminance signal LSS, and then transmitting the lamp luminance signal LSS to the MCU 19. The MCU 19 executes a firmware program for determining whether the luminance of the lamp is abnormal. When the luminance of the lamp is determined as abnormal, the MCU 19 outputs an abnormal signal ERR. The subsequent operation is similar to the first embodiment, and can be learnt by referring to the foregoing discussion, and is not to be iterated hereby. As such, the second embodiment is adapted for detecting the abnormal operation status of the lamp luminance, and instantly report to the CTC 30.

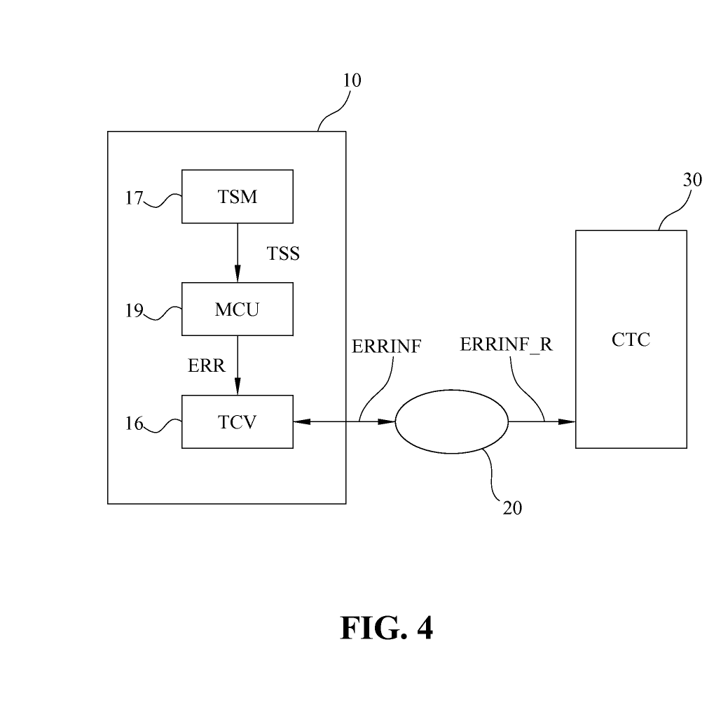

FIG. 4 is a schematic diagram illustrating a flat display apparatus adapted for reporting an abnormal operation status according to a third embodiment of the present invention. Referring to FIG. 4, the system includes a flat display apparatus 10, a network 20, and a control center (CTC) 30. The flat display apparatus 10 is adapted for instantly reporting an abnormal operation status of the flat display apparatus 10. The flat display apparatus 10 includes a temperature sensing module (TSM) 17, a micro control unit (MCU) 19, and an abnormal signal transceiver 16. The TSM 17 is adapted for detecting a temperature inside the flat display apparatus 10, and correspondingly generating a temperature signal TSS, and then transmitting the temperature signal TSS to the MCU 19. The MCU 19 executes a firmware program for determining whether the temperature inside the flat display apparatus is abnormal. When the temperature inside the flat display apparatus is determined as abnormal, the MCU 19 outputs an abnormal signal ERR. The subsequent operation is similar to the first embodiment, and can be learnt by referring to the foregoing discussion, and is not to be iterated hereby. As such, the third embodiment is adapted for detecting the abnormal operation status of the temperature inside the flat display apparatus, and instantly report to the CTC 30.

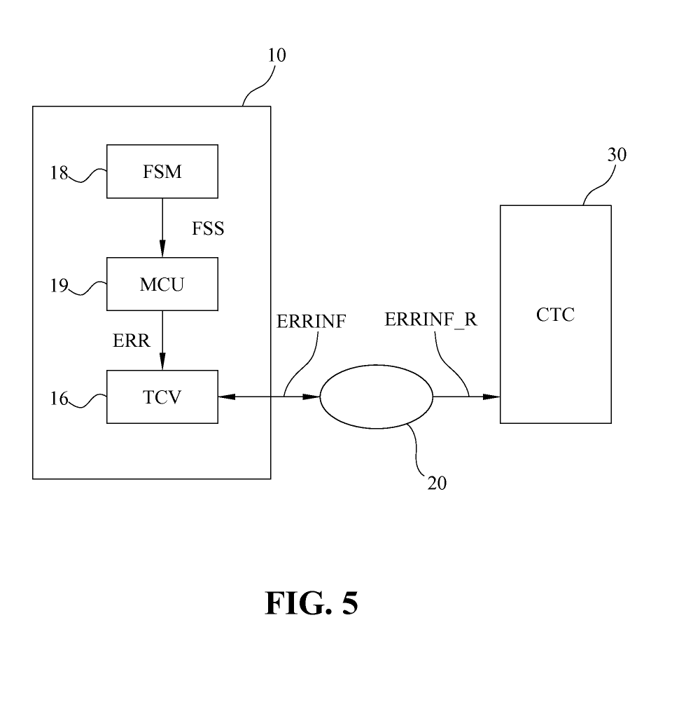

FIG. 5 is a schematic diagram illustrating a flat display apparatus adapted for reporting an abnormal operation status according to a fourth embodiment of the present invention. Referring to FIG. 5, the system includes a flat display apparatus 10, a network 20, and a control center (CTC) 30. The flat display apparatus 10 is adapted for instantly reporting an abnormal operation status of the flat display apparatus 10. The flat display apparatus 10 includes a fan speed sensing module (FSM) 18, a micro control unit (MCU) 19, and an abnormal signal transceiver 16. The FSM 18 is adapted for detecting a rotation speed of a fan inside the flat display apparatus 10, and correspondingly generating a fan speed signal FSS, and then transmitting the fan speed signal FSS to the MCU 19. The MCU 19 executes a firmware program for determining whether the rotation speed of the fan inside the flat display apparatus is abnormal. When the rotation speed of the fan inside the flat display apparatus is determined as abnormal, the MCU 19 outputs an abnormal signal ERR. The subsequent operation is similar to the first embodiment, and can be learnt by referring to the foregoing discussion, and is not to be iterated hereby. As such, the fourth embodiment is adapted for detecting the abnormal operation status of the rotation speed of the fan inside the flat display apparatus, and instantly report to the CTC 30.

It should be noted that the abnormal signal transceiver 16 is adapted for bidirectional transmission, and therefore in accordance with the flat display apparatus of the present invention, the CTC 30 is capable of outputting an instruction to the flat display apparatus 10. In other words, the flat display apparatus 10 is not only adapted for transmitting signals to the network 20, but also adapted for receiving signals from the network 20. The signals received from the network 20 can be then forwarded to a certain module for performing a predetermined processing, e.g., the backlight module simultaneously turning off all of the lamps or turning off the fan. In such a way, the present invention also provides a flat display apparatus having a bidirectional information transmission function.

In summary, the present invention provides a flat display apparatus adapted for reporting an abnormal operation status of the flat display apparatus, such as abnormal lamp operation, abnormal lamp luminance, abnormal display temperature, and abnormal rotation speed of the fan. The related abnormal information is then transmitted to the control center, maintenance center or management staff. The control center or the maintenance center can then send maintenance staff to go to repair. In such a way, the maintenance efficiency is improved. Meanwhile, the control center or the maintenance center can send an instruction to the display to instruct the display to execute a predetermined operation, so as to provide a more efficient instant monitoring function.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A flat display apparatus, adapted for reporting an abnormal operation status, comprising:
a backlight module, comprising a plurality of lamps, each of the lamps being coupled to a high voltage power supply, wherein two serially connected capacitors are parallel coupled to a joint between the lamp and the high voltage power supply, and a voltage at where the two capacitors are serially connected together is defined as a lamp signal;
an abnormal operation status detector, adapted for receiving the lamp signal transmitted from the backlight module, and converting the received lamp signal into a digital signal, and in accordance with a predetermined process determining whether the lamp signal indicates that there is any lamp in the backlight module is in an abnormal operation status, and then generating a corresponding lamp operation status signal;
a micro control unit (MCU), receiving the lamp operation status signal, and being adapted for generating an abnormal signal according to the lamp operation status signal and a predetermined determination condition; and
an abnormal signal transceiver, adapted for receiving the abnormal signal, and converting the received abnormal signal into an abnormal information having a suitable format, and transmitting the abnormal information to a wired network or a wireless network, wherein the abnormal signal transceiver is also adapted for receiving an instruction from the wired network or wireless network, and executing a predetermined operation according to the instruction received from the wired network or wireless network, thus achieving a bidirectional feedback.

2. The flat display apparatus according to claim 1, wherein the abnormal operation status detector comprises:
an analog-to-digital converter (ADC), adapted to convert the lamp signal into the digital signal; and
a controller, adapted for receiving the digital signal and conducting a predetermined operation in accordance with the predetermined process for generating the abnormal signal.

3. The flat display apparatus according to claim 2, wherein the predetermined process is a filtering process, and the predetermined operation comprises a digital filtering operation for eliminating interference caused by external noises.

4. The flat display apparatus according to claim 3, wherein the digital filtering process comprises counting a time of the digital signal with a counter facilitated with an internal clock or an external reference clock, and when the counted time exceeds a predetermined threshold value, the digital signal is taken as an effectively abnormal signal and a corresponding abnormal signal is outputted, and when the counted time does not exceed the predetermined threshold value, the digital signal is taken as an ineffectively abnormal signal and there is no abnormal signal generated thereby.

5. The flat display apparatus according to claim 1, wherein the abnormal operation status detector is a micro processor having a function of analog-to-digital conversion and executing a built-in firmware program equivalent to a filtering process for achieving a predetermined operation.

6. The flat display apparatus according to claim 1, further comprising a light sensing module, for detecting a luminance of the lamps, and correspondingly generating a lamp luminance signal, and then transmitting the lamp luminance signal to the MCU, wherein the MCU receives the lamp luminance signal and determines whether the luminance of the lamp is abnormal according to the predetermined determination condition.

7. The flat display apparatus according to claim 1, further comprising a temperature sensing module, for detecting a temperature inside the flat display apparatus, and correspondingly generating a temperature signal, and then transmitting the temperature signal to the MCU, wherein the MCU receives the temperature signal and determines whether the temperature inside the flat display apparatus is abnormal according to the predetermined determination condition.

8. The flat display apparatus according to claim 1, further comprising a fan speed sensing module, for detecting a rotation speed of a fan inside the flat display apparatus, and correspondingly generating a fan speed signal, and then transmitting the fan speed signal to the MCU, wherein the MCU receives the fan speed signal and determines whether the rotation speed of the fan inside the flat display apparatus is abnormal according to the predetermined determination condition.

9. A method for instantly reporting an abnormal operation status of a flat display apparatus, comprising:
providing a lamp signal representing an operation status of one of a plurality of lamps of a backlight module of the flat display apparatus to an abnormal operation status detector;
in accordance with a predetermined process, utilizing the abnormal operation status detector to determine whether the received lamp signal indicates that there is any lamp in the backlight module is in an abnormal operation status, and then generating a corresponding abnormal signal;
utilizing an abnormal signal transceiver for receiving the abnormal signal, and converting the received abnormal signal into an abnormal information having a suitable format, and transmitting the abnormal information to a far end receiver via a network; and
the receiver transmitting an instruction to the flat display apparatus via the network, thus achieving a bidirectional feedback.

10. The method according to claim 9, wherein each of the lamps is coupled with a high voltage power supply, wherein two serially connected capacitors are parallel coupled to a joint between the lamp and the high voltage power supply, and a voltage at where the two capacitors are serially connected together is defined as a lamp signal.

11. The method according to claim 9, wherein the abnormal operation status detector comprises:
an analog-to-digital converter (ADC), adapted to convert the lamp signal into the digital signal; and
a controller, adapted for receiving the digital signal and conducting a predetermined operation in accordance with the predetermined process for generating the abnormal signal.

12. The method according to claim 9, wherein the predetermined process is a filtering process, and the predetermined operation comprises a digital filtering operation for eliminating interference caused by external noises.

13. The method according to claim 12, wherein the digital filtering process comprises counting a time of the digital signal with a counter facilitated with an internal clock or an external reference clock, and when the counted time exceeds a predetermined threshold value, the digital signal is determined as an effectively abnormal signal and a corresponding abnormal signal is outputted, and when the counted time does not exceed the predetermined threshold value, the digital signal is determined as an ineffectively abnormal signal and there is no abnormal signal generated thereby.

14. The method according to claim 9, wherein the abnormal operation status detector is a micro processor having a function of analog-to-digital conversion and executing a built-in firmware program equivalent to a filtering process for achieving a predetermined operation.
